(19) United States
(12) Patent Application Publication
(10) Pub. No.: US 2010/0110030 A1
(43) Pub. Date: May 6, 2010

(54) Apparatus and method for inputting characters in computing device with touchscreen

(75) Inventor: Keun-Ho Shin, Suwon-si (KR)

Correspondence Address: DOCKET CLERK, P.O. DRAWER 800889, DALLAS, TX, 75380, US

(73) Assignee: Samsung Electronics Co., Ltd., Suwon-si (KR)

(21) Appl. No.: 12/589,935

(22) Filed: Oct. 29, 2009

(30) Foreign Application Priority Data
Nov. 3, 2008 (KR) 10-2008-0108327

(51) Int. Cl. G06F 3/041

(52) U.S. Cl. 345/173

(57) ABSTRACT

A computing device with a touchscreen capable of displaying characters in multiple languages includes and apparatus and method for inputting characters with a touchscreen. In the method, keys mapped to a plurality of characters are displayed on a touchscreen. If a press and a drag occur in a key region and a release occurs outside the key region, it is determined that one of the characters except a representative character of the key is input.

### CROSS-REFERENCE TO RELATED APPLICATION(S) AND CLAIM OF PRIORITY

The present application is related to and claims priority under 35 U.S.C. §119 to an application filed in the Korean Intellectual Property Office on Nov. 3, 2008 and assigned Serial No. 10-2008-0108327, the contents of which are incorporated herein by reference.

### TECHNICAL FIELD OF THE INVENTION

The present invention relates generally to a computing device with a touchscreen, and in particular, to an apparatus and method for inputting characters in a computing device with a touchscreen.

### BACKGROUND OF THE INVENTION

Modern devices, such as portable terminals and computers, have a character input function as a basic input means. For example, a portable terminal receives characters through a built-in keypad and a computer receives characters through a separate hardware of a keyboard. In this case, if a plurality of languages are supported, keys are mapped to characters independently with respect to the languages. For example, in a general computer keyboard, an English character ‘A’ and a Korean character ‘□’ are all mapped to one key. Moreover, in a portable terminal, an English character, a Korean character, and a numeral are all mapped to one key. For example, a numeral ‘1’, English characters ‘q’ and ‘x’, and a Korean character ‘|’ are all mapped to one key.

As described above, if a plurality of languages are mapped to one key, a user may change an input language through a corresponding key for input language conversion. That is, if the user is to input Korean characters and English characters in combination, the user must press down a language conversion key in order to input an English character after inputting a Korean character. Thus, if the user is to write a character string with a mixture of different languages, numerals, special characters, and symbols, the user is inconvenienced by having to press down the language conversion key frequently.

### SUMMARY OF THE INVENTION

To address the above-discussed deficiencies of the prior art, it is a primary aspect of the present invention to provide an apparatus and method for eliminating the inconvenience caused by a language conversion key input in a computing device with a touchscreen.

Another object of the present invention is to provide an apparatus and method for omitting a language conversion key input in a computing device with a touchscreen by using the input characteristics of the touchscreen.

Another object of the present invention is to provide an apparatus and method for replacing a language conversion key input by a drag operation in a computing device with a touchscreen.

Another object of the present invention is to provide an apparatus and method for determining an input character in a computing device with a touchscreen by using the drag direction after key touch.

According to an aspect of the present invention, a method for determining an input character in a computing device with a touchscreen includes: displaying keys mapped to a plurality of characters on a touchscreen; and if a press and a drag occur in a key region and a release occurs outside the key region, determining that one of the characters except a representative character of the key is input.

According to another aspect of the present invention, an apparatus for a computing device with a touchscreen includes: a touchscreen displaying keys mapped to a plurality of characters; and a determining unit determining, if a press and a drag occur in a key region and a release occurs outside the key region, that one of the characters except a representative character of the key is input.

Before undertaking the DETAILED DESCRIPTION OF THE INVENTION below, it may be advantageous to set forth definitions of certain words and phrases used throughout this patent document: the terms “include” and “comprise,” as well as derivatives thereof, mean inclusion without limitation; the term “or,” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, such a device may be implemented in hardware, firmware or software, or some combination of at least two of the same. It should be noted that the functionality associated with any particular controller may be centralized or distributed, whether locally or remotely. Definitions for certain words and phrases are provided throughout this patent document, those of ordinary skill in the art should understand that in many, if not most instances, such definitions apply to prior, as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIGS. 1A to 1C illustrate diagrams for the types of input patterns identified by a computing device with a touchscreen according to an embodiment of the present invention;

FIG. 2 illustrates a block diagram of a computing device with a touchscreen according to an embodiment of the present invention; and

FIG. 3 illustrates a flow chart for a process for determining a character input of a computing device with a touchscreen according to an embodiment of the present invention.

### DETAILED DESCRIPTION OF THE INVENTION

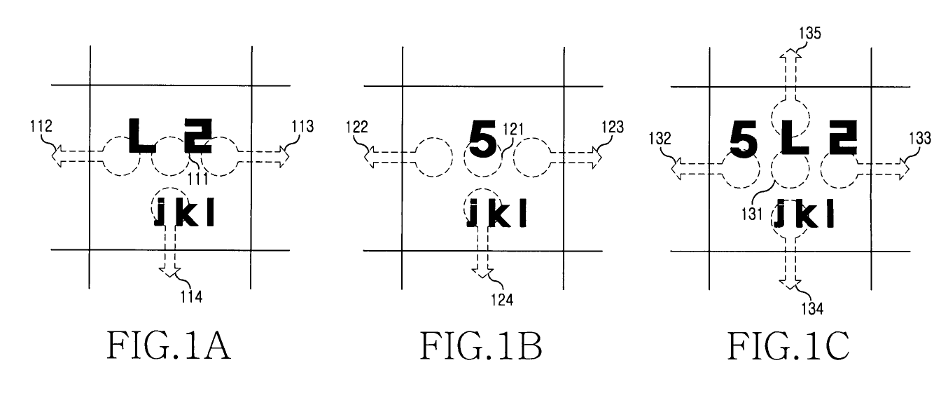

FIGS. 1A through 3 discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged device.

The present invention provides an apparatus and method for eliminating the inconvenience caused by a language conversion key input in a computing device with a touchscreen. Herein, the computing device may be any device having a touchscreen as an input means, such as cellular phones, personal portable phones, complex wireless terminals, IMT2000 terminals, laptop computers, and desktop computers.

Input patterns identifiable through a touchscreen include press, drag, and release. In determining the input of a character mapped to a key displayed on a touchscreen, if a press and a release occur in a region of the corresponding key, a computing device determines that the corresponding character is inputted. However, a computing device according to the present invention uses a press and a release as well as a drag to determine an input character.

In the case of keys mapped to Korean characters and English characters, input character determination according to the present invention is the same as illustrated in FIG. 1A. FIG. 1A illustrates keys mapped to Korean characters ‘ [symbol] ’ and ‘ [symbol] ’ and English characters ‘j’, ‘k’ and ‘l’ displayed on the touchscreen.

Referring to FIG. 1A, the computing device identifies four patterns of inputs 111 to 114 for each key. The first input 111 corresponds to the occurrence of a press and a release in a key region, and the occurrence of the first input 111 is determined as the input of a Korean character ‘ [symbol] ’ or ‘ [symbol] ’. According to the repeated occurrence of the first input 111, the Korean characters ‘ [symbol] ’ and ‘ [symbol] ’ are toggled. The second input 112, the third input 113 and the fourth input 114 correspond to the case where a press occurs in a key region, a drag occurs across a key boundary and a release occurs outside the key region, the occurrence of which is determined as the input of an English character. Herein, the second input 112, the third input 113 and the fourth input 114 correspond respectively to English characters and are discriminated by the drag directions, i.e., which direction of key boundary was passed. For example, if the second input 112 occurs, it is determined as the input of an English character ‘j’; if the third input 113 occurs, it is determined as the input of an English character ‘k’; and if the fourth input 114 occurs, it is determined as the input of an English character ‘l’.

In the case of keys mapped to numerals and English characters, input character determination according to the present invention is the same as illustrated in FIG. 1B. FIG. 1B illustrates keys mapped to a numeral ‘5’ and English characters j', k' and ‘l’ displayed on the touchscreen.

Referring to FIG. 1B, the computing device identifies four patterns of inputs 121 to 124 for each key. The first input 121 corresponds to the occurrence of a press and a release in a key region, and the occurrence of the first input 121 is determined as the input of a numeral ‘5’. The second input 122, the third input 123 and the fourth input 124 correspond to the case where a press occurs in a key region, a drag occurs across a key boundary and a release occurs outside the key region, the occurrence of which is determined as the input of an English character. Herein, the second input 122, the third input 123 and the fourth input 124 correspond respectively to English characters and are discriminated by the drag directions, i.e., which direction of key boundary was passed. For example, if the second input 122 occurs, it is determined as the input of an English character ‘j’; if the third input 123 occurs, it is determined as the input of an English character ‘k’; and if the fourth input 124 occurs, it is determined as the input of an English character ‘l’.

In the case of keys mapped to Korean characters, numerals and English characters, input character determination according to the present invention is the same as illustrated in FIG. 1C. FIG. 1C illustrates keys mapped to Korean characters ‘ [symbol] ’ and ‘ [symbol] ’, a numeral ‘5’ and English characters ‘j’, ‘k’ and ‘l’ displayed on the touchscreen.

Referring to FIG. 1C, the computing device identifies five patterns of inputs 131 to 135 for each key. The first input 131 corresponds to the occurrence of a press and a release in a key region, and the occurrence of the first input 131 is determined as the input of a Korean character ‘ [symbol] ’ or ‘ [symbol] ’. According to the repeated occurrence of the first input 131, the Korean characters ‘ [symbol] ’ and ‘ [symbol] ’ are toggled. The second input 132, the third input 133, the fourth input 134 and the fifth input 135 correspond to the case where a press occurs in a key region, a drag occurs across a key boundary and a release occurs outside the key region, the occurrence of which is determined as the input of an English character. Herein, the second input 132, the third input 133, the fourth input 134 and the fifth input 135 correspond respectively to English characters and numerals, and are discriminated by the drag directions, i.e., which direction of key boundary was passed. For example, if the second input 132 occurs, it is determined as the input of an English character ‘j’; if the third input 133 occurs, it is determined as the input of an English character ‘k’; if the fourth input 134 occurs, it is determined as the input of an English character ‘l’; and if the fifth input 135 occurs, it is determined as the input of a numeral ‘5’.

Hereinafter, the configuration and operation of a computing device determining an input character according to an embodiment of the present invention will be described in detail with reference to the accompanying drawings.

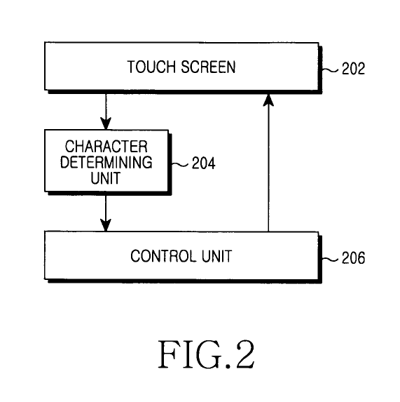

FIG. 2 illustrates a block diagram of a computing device with a touchscreen according to an embodiment of the present invention.

Referring to FIG. 2, the computing device includes a touchscreen 202, a character determining unit 204, and a control unit 206.

The touchscreen 202 has a display function for displaying visual information and an input function for detecting a touch input according to a physical touch. That is, under the control of the control unit 206, the touchscreen 202 displays the state, numeral, character, image, and video of the computing device in a visual form. Particularly, under the control of the control unit 206, the touchscreen 202 displays keys mapped to a plurality of characters. Herein, the characters include a plurality of languages. For example, the characters may include Korean characters/English characters, numerals/English characters, or Korean characters/numerals/English characters. Also, the touchscreen 202 provides information such as the occurrence position, pressure level and pressure range of a touch input by a user to the character determining unit 204. For example, the touchscreen 202 includes one of a CRT, a LCD and an OLED for the display function. Also, the touchscreen 202 includes a touch panel for the input function.

The character determining unit 204 determines an input character according to a touch input generated on the touchscreen 202, and provides the determination result to the control unit 206. Herein, the character determining unit 204 determines the input character by using a press, a drag and a release caused by a touch. The input character determination function is as follows. If a press occurs in a key region, the character determining unit 204 records the motion trajectory of a touch, i.e., the trajectory of a drag. If a release occurs during the record of the drag trajectory, the character determining unit 204 determines an input character. Herein, if the occurrence position of the release is outside the key region, the character determining unit 204 determines that a language/character corresponding to the drag direction is input. Herein, the language/character corresponding to the drag direction and the representative character may vary depending on the intentions of a designer of the computing device and an implementer of the present invention.

The control unit 206 controls an overall operation of the computing device. For example, the control unit 206 provides video information, which is to be displayed to the user, to the touchscreen 202, and processes a function corresponding to an input character provided from the character determining unit 204. When the determination result of the character input is provided from the character determining unit 204, if an edit window displaying the input character is displayed, the control unit 206 controls the touchscreen 202 to display the determined character on the edit window.

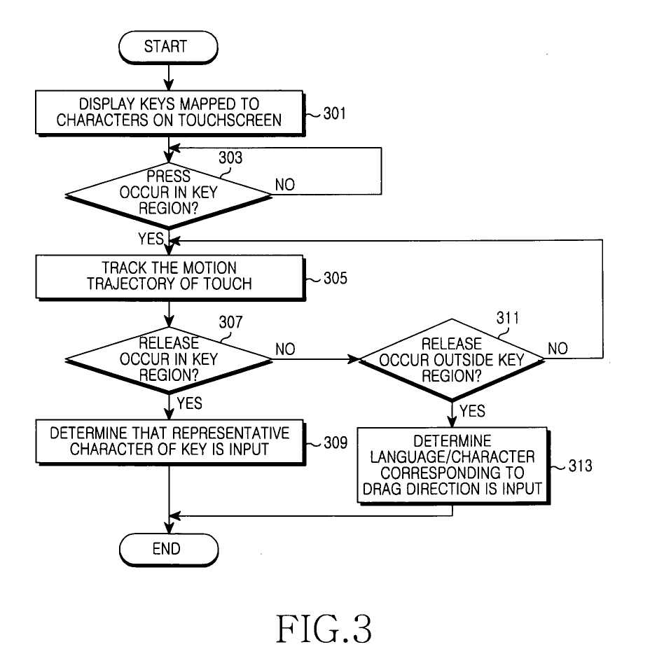

FIG. 3 illustrates a flow chart for a process for determining a character input of the computing device with a touchscreen according to an embodiment of the present invention.

Referring to FIG. 3, in step 301, the computing device displays keys mapped to a plurality of characters on the touchscreen. Herein, the characters include a plurality of languages. For example, the characters may include Korean characters/English characters, numerals/English characters, or Korean characters/numerals/English characters.

In step 303, the computing device determines whether a press occurs in a key region. That is, the computing device determines whether a user's touch for a character input occurs.

If a press occurs in the key region, the computing device proceeds to step 305. In step 305, the computing device tracks the motion trajectory of the touch. That is, if the movement of a touch position, i.e., a drag occurs after the occurrence of the press, the computing device records the trajectory of the drag.

In step 307, the computing device determines whether a release occurs in a key region during the record of the drag trajectory. If a release does not occur in the key region (in step 307), the computing device proceeds to step 311. In step 311, the computing device determines whether a release occurs outside the key region. If a release does not occur outside the key region (in step 311), the computing device returns to step 305. That is, the computing device repeats steps 305, 307 and 309 to determine whether a release occurs and whether the occurrence position is in the key region.

If a release occurs in the key region (in step 307), the computing device proceeds to step 309. In step 309, the computing device determines that a representative character of the key is input. Herein, the representative character may vary depending on the intentions of a designer of the computing device and an implementer of the present invention. For example, in the case of FIG. 1C, the computing device determines that a Korean character ‘ [symbol] ’ is input. Herein, if an edit window displaying an input character is displayed, the computing device displays the determined character on the edit window.

If a release occurs outside the key region (in step 311), the computing device proceeds to step 313. In step 313, the computing device determines that the language/character corresponding to the drag direction is input. For example, in the case of FIG. 1C, the computing device determines that one of English characters ‘j’, ‘k’ and ‘l’ and a numeral ‘5’ corresponding to the drag direction is input. Herein, the language/character corresponding to the drag direction may vary depending on the intentions of a designer of the computing device and an implementer of the present invention. Herein, if an edit window displaying an input character is displayed, the computing device displays the determined character on the edit window.

As described above, the present invention replaces a language conversion key input by a drag operation in a computing device with a touchscreen, thereby making it possible to eliminate the user's inconvenience caused by the language conversion key input.

Although the present disclosure has been described with an exemplary embodiment, various changes and modifications may be suggested to one skilled in the art. It is intended that the present disclosure encompass such changes and modifications as fall within the scope of the appended claims.

What is claimed is:

1. A method for determining an input character in a computing device with a touchscreen, the method comprising:
displaying at least one key mapped to a plurality of characters on a touchscreen; and
selecting one of the plurality of characters in response to sequence of user inputs within a key region defining the at least one key.

2. The method of claim 1, wherein the sequence of user inputs comprises a press and a drag occurring in the key region and a release occurring outside the key region.

3. The method of claim 2, wherein selecting comprises determining the one of the plurality characters corresponding to a direction of the drag.

4. The method of claim 1, wherein the sequence of user inputs comprises a plurality of press and release actions in the region.

5. The method of claim 4, wherein selecting comprises toggling between at least two of the plurality characters in response to each press and release action.

6. The method of claim 1, wherein the sequence of user inputs comprises a press and a release in the region; and
wherein selecting comprises determining a representative character of the key.

7. The method of claim 1, wherein the plurality of characters include a plurality of languages.

8. An apparatus for a computing device with a touchscreen, comprising:
a touchscreen configured to display a plurality of keys, each of the plurality of keys mapped to a plurality of characters; and
a determining unit configured to select one of the plurality of characters in response to sequence of user inputs within a key region defining at least one of the plurality of keys.

9. The apparatus of claim 8, wherein the sequence of user inputs comprises a press and a drag occurring in the key region and a release occurring outside the key region.

10. The apparatus of claim 9, wherein the determining unit is configured to determine the one of the plurality characters corresponding to a direction of the drag.

11. The apparatus of claim 8, wherein the sequence of user inputs comprises a plurality of press and release actions in the region.

12. The apparatus of claim 11, wherein the determining unit is configured to toggle between at least two of the plurality characters in response to each press and release action.

13. The apparatus of claim 8, wherein the sequence of user inputs comprises a press and a release in the region; and
wherein determining unit is configured to determine a representative character of the key.

14. The apparatus of claim 8, wherein the plurality of characters include a plurality of languages.

15. A portable device comprising:
a touchscreen, the touchscreen configured to display a plurality of keys, each of the plurality of keys mapped to a plurality of characters; and
a determining unit configured to select one of the plurality of characters in response to sequence of user inputs within a key region defining at least one of the plurality of keys.

16. The device of claim 8, wherein the sequence of user inputs comprises at least one of:
a press and a drag occurring in the key region and a release occurring outside the key region; and
a plurality of press and release actions in the region.

17. The device of claim 16, wherein the determining unit is configured to determine the one of the plurality characters corresponding to a direction of the drag.

18. The device of claim 16, wherein the determining unit is configured to toggle between at least two of the plurality characters in response to each press and release action.

19. The device of claim 15, wherein the plurality of characters include a plurality of languages.

20. The device of claim 15, wherein the determining unit determines that the selected character is input if a press occurs in the key region and a release occurs in the key region.
